(19) United States
(12) Patent Application Publication
(10) Pub. No.: US 2013/0133909 A1
(43) Pub. Date: May 30, 2013

(54) ENHANCED VIBRATIONAL OR HAMMERING APPARATUS

(71) Applicants: Roland Greenwood, Victoria (AU); Peter Evan Powell, Timaru (NZ)

(72) Inventors: Roland Greenwood, Victoria (AU); Peter Evan Powell, Timaru (NZ)

(21) Appl. No.: 13/699,873

(22) PCT Filed: May 24, 2011
(86) PCT No.: PCT/NZ2011/000084

§ 371 Date: Jan. 22, 2013

(30) Foreign Application Priority Data
May 25, 2010 (NZ) 585598

(51) Int. Cl. B25D 11/00

(52) U.S. Cl. CPC B25D 11/00
USPC 173/90

(57) ABSTRACT

Vibrational apparatus to direct stress waves (eg. to a bit 2 or other downhole tool) by generating vibrations as a consequence of shuttling responsive to relative rotational movement between magnetic arrays and wherein there is, or can be, a use of a system (whether rebound, recoil, spring, pneumatic, magnetic or not) able at least in part to return acquired potential energy in addition to any acquired at the same time by the interacting magnetic arrays. A free travel distance can be provided for one of said components prior to the onset of any substantial collection of energy from the movement (relative) of that component in a direction (eg, uphole) for use in return travel (eg, downhole) preferably synchronized, or synchronizable, to enhance the return travel causing forces of any repulsive and/or attractive forces generated otherwise than by the said magnetic arrays.

The present invention relates to enhanced vibrational or hammering apparatus.

More particularly the invention relates to a recoil energy capturing system in an apparatus providing a vibrational output. Such a capturing system can be useful in a downhole application either for passing vibration to a bit or other downhole tool or for generating a sound or stresswave output, that may be of relevance, within a subground structure.

Such an energy capturing system can be used to assist motion or relative motion that is desired, and can if wanted (with little or no damping) be used to soften unwanted directional stress waves.

Examples of apparatus that can benefit from such enhancement have been disclosed in our PCT/NZ2005/000329, and PCT/NZ2008/000217. Other examples include our U.S. Ser. No. 12/461738.

It is an object of the present invention to provide downhole a unidirectional or bidirectional output from a relatively shutting component, the kinetic energy of which is enhanced in at least one direction by a storage potential energy resultant from relative movement in the opposite direction.

It is a further object or alternative object of the present invention to provide vibrational apparatus (whether downhole or not) with a means of softening a stress wave relative to another in the opposite direction or at least to offer the public a choice.

It is another object, or further object, of the present invention to provide vibrational apparatus (whether a downhole apparatus or not) suitable for transmitting vibrations to a bit or other downhole tool yet which, by recoil energy capture (preferably a softened rebound system of some kind whether spring based or not) of a force, or of forces, can be returned to assist movement in a downhole direction.

It is a further or alternative object of the present invention to use a free travel distance between a shuttle and spring to collect, in a downhole situation, the upward (“up-hole”) action of the shuttle as potential energy and to return that energy as kinetic energy of the shuttle.

The invention includes apparatus and/or methods, reliant on shuttling [optionally involving magnetic interactions], where shuttling in one direction is to provide a stress wave output and shuttling in the other direction is not required to provide a stress wave output [other than arises from a need to reverse direction], wherein shuttling in said other direction is used to capture energy as potential energy and then return that potential energy as kinetic energy.

In another aspect the invention is vibrational apparatus (eg, as might be suitable as part of a downhole hammer system) having components able to be caused to rotate relative to each other about an axis of relative rotation, such components each carrying a magnetic array able, upon such relative rotation, to cause a vibration generating shuttling affect;

wherein one direction of the shuttling is resisted by an energy recoil system or a rebound arrangement.

Preferably the shuttling is resisted by any arrangement able to resist the motion, preferably without any substantial damping or with no damping, by absorbing kinetic energy as potential energy and then releasing that potential energy as kinetic energy.

Whilst mechanical, pneumatic, magnetic, etc spring-like arrangements are contemplated, any single or multiple option can be used.

In another aspect the invention is downhole apparatus having components able to be caused to rotate relative to each other about an axis of relative rotation, such components each carrying a magnetic array able, upon such relative rotation, to cause downhole hammering as a result of a shuttling affect;

wherein one direction of the shuttling is resisted by an energy recoil system or a rebound arrangement.

Preferably the resistance in the vibrational apparatus or downhole apparatus is to reduce uphole shock and/or to assist downward movement of the shuttling system.

Preferably the shuttling is resisted by any arrangement able to resist the motion, preferably without any substantial damping or with no damping, by absorbing kinetic energy as potential energy and then releasing that potential energy as kinetic energy.

Whilst mechanical, pneumatic, magnetic, etc spring-like arrangements are contemplated, any single or multiple option can be used.

Optionally, a free travel distance or substantially free travel distance can be provided for one of said components prior to the onset of any substantial collection of energy from the movement (relative) of that component in a direction (eg, uphole) for use in return travel (eg, downhole) preferably synchronized, or synchronizable, to enhance the return travel causing forces of any repulsive and/or attractive forces generated otherwise than by the said magnetic arrays.

In another aspect the invention is vibrational apparatus (eg, as might be suitable as part of a downhole hammer system);

wherein the apparatus comprises or includes components able to be caused to rotate relative to each other about an axis of relative rotation, such components each carrying .a magnetic array able, upon such relative rotation, to cause a reciprocating affect (i.e., some component(s) shuttles relative to some component(s))

with the proviso that one direction of the relative movement of the reciprocating affect is at least in part resisted as potential energy is acquired and the other direction relative movement of the reciprocating affect is at least in part assisted by return of at least part of the potential energy as kinetic energy.

Optionally, a free travel distance or substantially free travel distance can be provided for one of said components prior to the onset of any substantial collection of energy from the movement (relative) of that component in a direction (eg, uphole) for use in return travel (eg, downhole) preferably synchronized, or synchronizable, to enhance the return travel causing forces of any repulsive and/or attractive forces generated otherwise than by the said magnetic arrays.

In another aspect the invention is vibrational apparatus to direct stress waves (for example to a bit or other downhole tool);

wherein vibrations are generated as a consequence of shuttling responsive to relative rotational movement between magnetic arrays;

and wherein there is, or can be, a use of a system (whether rebound, recoil, spring, pneumatic, magnetic or not) able at least in part to return acquired potential energy in addition to any acquired at the same time by the interacting magnetic arrays.

Preferably the system is tuned to synchronise somewhat with the onset of return shuttle travel.

The invention also is downhole vibrational apparatus to a bit or other downhole tool

wherein vibrations are generated as a consequence of shuttling responsive to relative rotational movement between magnetic arrays;

and wherein there is or can be a use of a rebound or re-coil system (whether spring based or not) able to apply a return force or forces to assist some directional shuttling movement in the downhole direction.

Optionally, a free travel distance or substantially free travel distance can be provided for one of said components prior to the onset of any substantial collection of energy from the movement (relative) of that component in a direction (eg, uphole) for use in return travel (eg, downhole) preferably synchronized, or synchronizable, to enhance the return travel causing forces of any repulsive and/or attractive forces generated otherwise than by the said magnetic arrays.

In still another aspect the invention is drilling or downhole apparatus carried by, or as part of, its drill or downhole string, [and preferably having in a more uphole position than any bit or downhole tool], a vibrational assembly;

wherein the vibrational assembly by shuttling is adapted to provide hammering or like vibrations that are to pass to the bit, other downhole tool or elsewhere [eg, for detection];

[and wherein preferably the vibrational assembly preferably includes complementary magnetic array pairs, each of which array of a pair is able to interact with its complementary magnetic array upon relative rotation between them [eg, about a rotational axis at least substantially aligned with or parallel with the drilling axis or downhole axis]];

and wherein relative rectilinear movement in the uphole direction between the complementary arrays is directly or indirectly resisted at least in part by an energy recoil system or a rebound system able to apply return force or forces (i.e., in the downhole direction) directly or indirectly to shuttling in the downhole direction.

Optionally, a free travel distance or substantially free travel distance can be provided for one of said components prior to the onset of any substantial collection of energy from the movement (relative) of that component in a direction (eg, uphole) for use in return travel (eg, downhole) preferably synchronized, or synchronizable, to enhance the return travel causing forces of any repulsive and/or attractive forces generated otherwise than by the said magnetic arrays.

In an aspect the invention is a vibrational system reliant on a shuttling mass to indirectly or directly generate a vibrational output and a repulsion system able to affect the shuttling mass from one end of its shuttling stroke thereby to assist what is otherwise the shuttling drive insofar as reversal from one direction is concerned.

The invention is also a recoil device or recoil devices for use in a shuttling system to assist with the recoil the reversal of (relative) movement of the shuffle; wherein the shuttle stroke (rectilinear or other) is greater, or is to be greater, than any free or substantially free travel of the recoil device(s).

In yet another aspect the invention is hammering apparatus of two subassemblies having a striking direction of the stroking of one subassembly relative to the other;

wherein the two subassemblies
(I) as a consequence of
   (A) intermittent like pole and unlike pole interactions, causable by relative rotation about a rotational axis (preferably at least parallel to the striking direction) between at least one magnetic array carried by each subassembly, or
   (B) intermittent like pole/unlike pole interactions and, in phase, intermittent unlike pole/like pole interactions, causable by relative rotation about a rotational axis (preferably at least parallel to the striking direction) between magnetic array pairings, where each array of a pair is on a different said subassembly,
(II) have one of the subassemblies during stroking either
   (A) intermittently being both (but out of phase) pushed against or pulled in the striking direction, or
   (B) intermittently being both (but out of phase) pushed against/pulled against and pulled in/pushed in the striking direction;

and wherein there is an interactive arrangement between the subassemblies, not (necessarily) dependent on relative rotation, able to resist by storing energy over at least a last region of movement of said one subassembly when moving opposite to the striking direction and to use energy, so stored, to assist acceleration of the said one subassembly in the striking direction.

The interactive arrangement able to resist by storing energy preferably allows some relatively of movement prior to the onset of the energy collection (eg. free travel).

The interactive arrangement can be any potential energy arrangement able to release the energy as kinetic energy of said one subassembly. Examples are as herein described. One example may be interacting like pole magnets or sets of like pole magnetic pairings able to absorb momentarily the kinetic energy prior to its release as kinetic energy.

Preferably there is collection of up-hole relative movement of a downhole shuttle carrying magnets as potential energy prior to its return as kinetic energy to the shuttle.

For example a nonlinear staggering of like pole pairs in or about the stroking axis can soften the halting of the movement away from the striking direction yet still be able to return potential energy as kinetic energy.

Optionally, a free travel distance or substantially free travel distance can be provided for one of said components prior to the onset of any substantial collection of energy from the movement (relative) of that component in a direction (eg, uphole) for use in return travel (eg, downhole) preferably synchronized, or synchronizable, to enhance the return travel causing forces of any repulsive and/or attractive forces generated otherwise than by the said magnetic arrays.

In another aspect the invention is a kinetic apparatus downhole, or suitable for use downhole, so as to provide a hammering action output as a consequence of relative shuttling between assemblies each with at last one magnetic array of the other responsive to a drive that causes relative rotation between the assemblies; wherein not linking or mutually tethering the assemblies can store as potential energy some of the kinetic energy of one stroke direction of the relative shuttling to enhance the return stroke as kinetic energy.

As used herein the term “and/or” means “and” or “or”. In some circumstances it can mean both.

As used herein the term “(s)” following a noun means one or both of the singular or plural forms.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

A preferred form of the present invention will now be described with reference to the accompany drawings in which

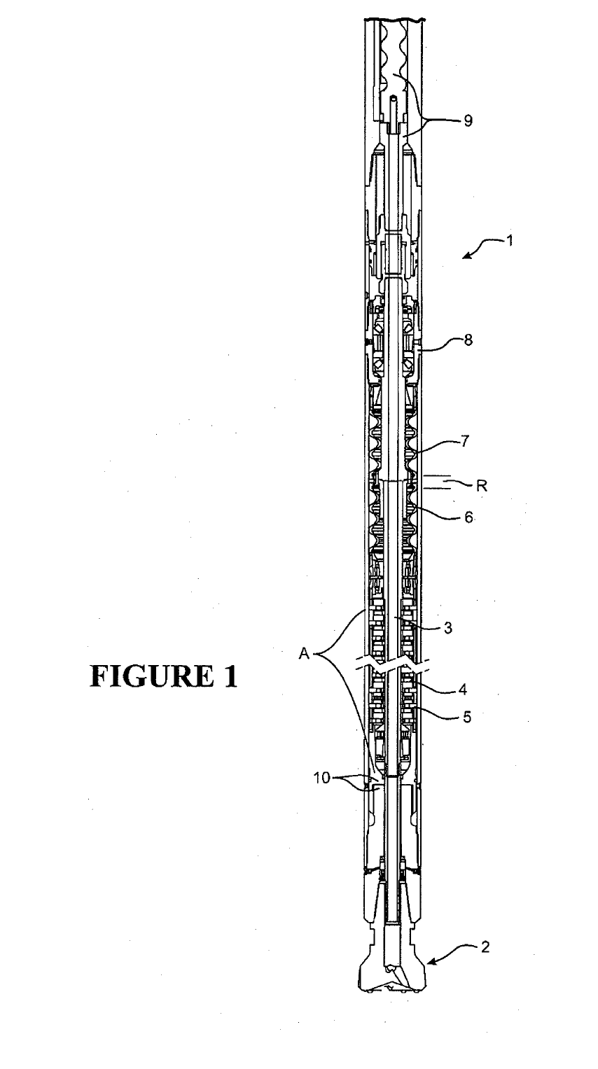

FIG. 1 shows in diagrammatic view a downhole structure being the lower region of a drill string to a bit or other downhole tool,

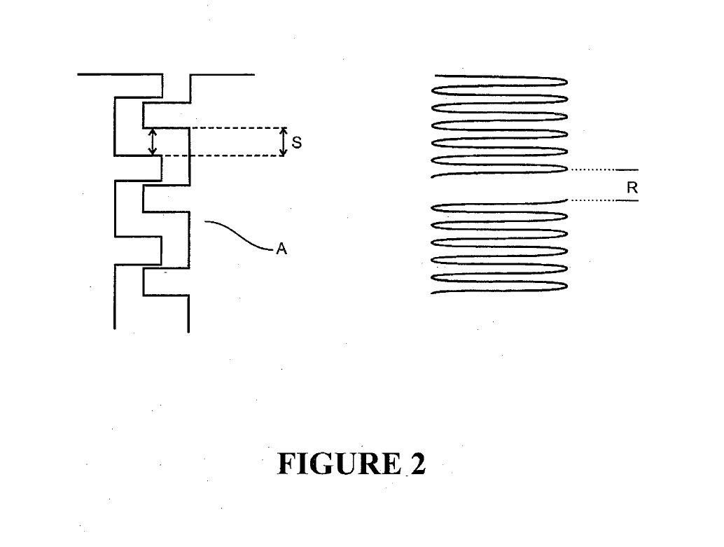

FIG. 2, by reference to, a spaced compression spring recoil system shows shuttle travel distance “S” as greater than free travel distance “R” of the recoil system,

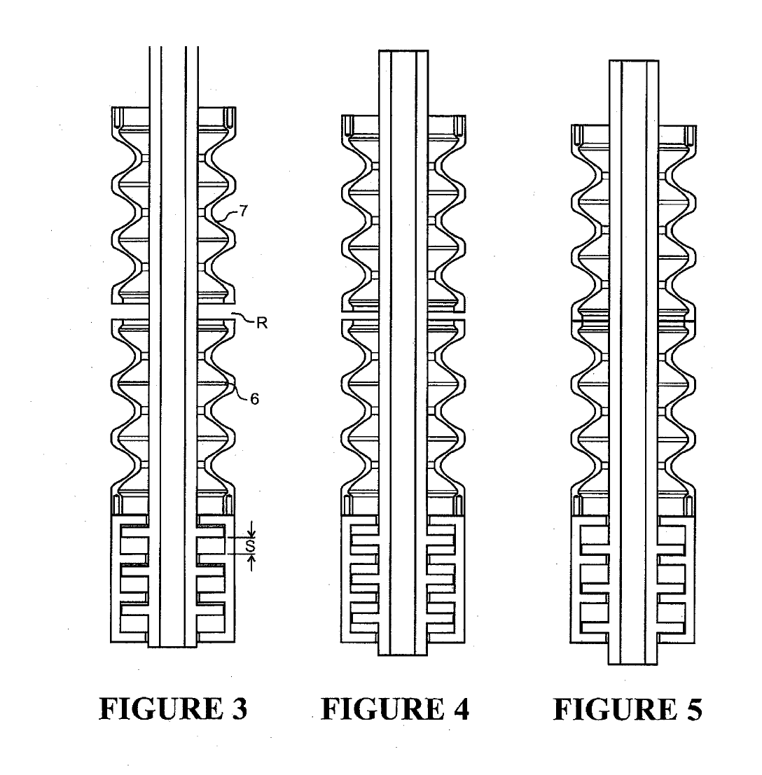

FIG. 3 shows the free travel gap between two spring forms when the magnetic array is at the bottom of a downward stroke,

FIG. 4 shows the closing of the free travel gap mid stroke, and

FIG. 5 shows compression of both springs (eg. at top of the stroke in the full recoil position and fully charged for assisting the downward stroke).

The description hereinafter is primarily in respect of providing a hammering affect downhole to a bit or tool. It need not however be so restricted as the energy capture and recoil or rebound system of the present invention has application with any suitable application for the use of interactive magnetic arrays able, as a consequence of relative rotation, to cause a reciprocation shuttling or the like effect able to serve a purpose, eg, stress wave generation for seismic purposes.

The present invention, by capturing potential energy momentarily in and selectively in one direction over the other, is able to buffer the effect of movement in one direction and use that movement against the energy capturing system to enhance movement in the opposite direction for the purpose of stress wave generation. In the case of a downhole hammering arrangement, such as shown in FIG. 1, this means that less energy need be used to achieve the same degree of downhole directed hammering. It also means less stress wave exposure to any delicate mechanisms and/or electronics more uphole in a drill string or downhole string.

In the preferred embodiment shown in FIG. 1 there is shown a drill string 1 having a bit 2 at lower end. Any suitable alternative tool can be provided.

Leading to the bit and moveable independently of the drill string is a spline linked shaft system which includes a centre shaft 3 that can provide drilling fluid to the drill bit as well as drive rotation of the drill bit. Some arrays of magnets carried by one or other of the shaft or the drill string casing, or both, move rotationally as well as axially relative to each other (for example as explained in our earlier patent specifications).

By way of example, magnetic arrays of a first kind and magnetic arrays can be provided so that an array of each kind, as a pair, can interact as relative rotation is caused (eg. by rotating one array, rotating the other array, or some mixture of both) to provide for at least substantially axial relative movement [eg. shuttling].

Options include splining or fixing each array of a different kind respectively to a shaft within the casing or to the casing itself, one array kind (preferably linked to other arrays of the same kind) can shuttle relative to the other kind array(s). This can involve a floating “shuttle” not fixed axially to either as said shaft within the casing or the casing itself. Instead the “shuttle”, if there is such axially fixing, can be a splined shaft region and carried arrays.

The shuttling affect is not determined by what may or may not be the shuttle itself.

Shown by the letter A is the extent of a preferred shuttling mass which has arrays 5 driveable in rotation by the shuttling centre shaft 3. Shown generally as 4 are those arrays not carried by and/or driveable by that shaft, i.e., which are fixed relative to the casing of the drill string 1.

Shown as 6 and 7 are recoil arresters in the form of single or multiple springs (eg. of titanium or other suitable material) able to butt up against a thrust bearing assembly 8.

Shown above the bearing assembly, but still able to drive rotation of the shaft system 3, and thus through appropriate splines etc the bit 2, is a mud motor system 9. Such a PDM rotates the central shaft assembly which to accommodate the reciprocation of the shuttling mass as appropriate interconnections.

Shown as 10 are the two parts of impact faces which directly (solid to solid) are to contact at the downward stroke of the shuttling mass of the range “A”. In some less preferred forms some contact liquid surface can be provided for that purpose but that need not be the case.

With the downward impact of the shuttling mass being such as to favour vibration down to the bit to or other downhole tool or generally outwardly and/or downwardly into the subterranean strata, the reverse is not the case. This is because the recoil arresting characteristics of the energy capture, recoil system and/or rebound system.

This energy return system is preferably not to dampen wholly, or to any substantial extent, but rather is designed to capture as much energy as possible and then to use that compaction or storage of the energy as potential energy to assist the return movement of the shuttling mass A. Persons skilled in this will appreciate the alternatives that can be used in addition to mere springs. Other systems include pneumatic spring systems of any kind, magnetic rebound systems, and the like.

The reflective energy/wave/force can, if desired, be synchronized with the primary downward wave/force.

A recoil device(s) (mechanical spring, air/fluid spring, magnetic repulsion etc) constrained at one end and which operates synchronously with a shuttling mass (piston etc) which is propelled (by magnetic force, compressed gas or pressurised fluid etc) toward the recoil device such that there is a free travel distance (“R”) which is always less than the amplitude (i.e., stroke) of the shuttle movement “S”. This allows the recoil device to be energized and deliver stored potential energy as kinetic energy back into the shuttle in a synchronized manner.

A preferred recoil device(s) to resist one direction of shuttling (optionally mechanical spring, air/fluid spring, magnetic repulsion etc) can allow travelling over a free travel distance to allow the device to operate synchronously with the shuttling mass to enhance the reversal of the shuttling mass (whether by magnetic force, compressed gas or pressurised fluid or otherwise). The free travel distance is less than the amplitude or stroke of movement of the shuttling mass.

As an example only, as it need not be a compression system, free travel distance between the preferred multiple (eg. two) springs 6 and 7 is preferably less than the amplitude of the shuttle movement (i.e., of the magnetic arrays) to allow for the spring(s) compression. By choice of the free travel distance [for example the sum of the distance of the free travel distance and the distance that the spring will compress] and dependent on the coefficient of restitution of the spring, the reflection can be synchronised with the downward stroke and therefore add energy to the downward stroke as opposed to creating a separate wave pattern.

In this respect see FIGS. 3, 4 and 5 where the free travel gap R is shown between springs 6 and 7 (both above A).

FIG. 3 shows the free travel gap R between two spring forms 6, 7 (optionally fixed bottom and top respectively) when the magnetic array ‘A’ is at the bottom of a downward stroke.

FIG. 4 shows the closing of the free travel gap R mid stroke.

FIG. 5 shows compression of both springs 6 and 7 (eg. at top of the stroke in the full recoil position and fully charged for assisting the downward stroke).

During the downward stroke the condition as in FIG. 4 occurs prior to the hammering and the condition as in FIG. 3 occurs at least during the start of the upward stroke.

Optionally if, the recoil device is fitted to a magnetic hammer, the rotation speed of the magnetic array is altered to match the axial pulsations of the shuttle such that the shuttle movement is synchronized with the recoil device. Such applications are useful when drilling through different substrates.

If magnetic, the distance R can be zero as compression would start immediately even if incrementally applied.

1-20. (canceled)

21. A hammering apparatus of two subassemblies having a striking direction of the stroking of one subassembly relative to the other;
wherein the two subassemblies
(I) as a consequence of
(A) intermittent like pole and unlike pole interactions, causable by relative rotation about a rotational axis (preferably at least parallel to the striking direction) between at least one magnetic array carried by each subassembly, or
(B) intermittent like pole/unlike pole interactions and, in phase, intermittent unlike pole/like pole interactions, causable by relative rotation about a rotational axis (preferably at least parallel to the striking direction) between magnetic array pairings, where each array of a pair is on a different said subassembly,
(II) have one of the subassemblies during stroking either
(A) intermittently being both (but out of phase) pushed against or pulled in the striking direction, or
(B) intermittently being both (but out of phase) pushed against/pulled against and pulled in/pushed in the striking direction;
and wherein there is an interactive arrangement between the subassemblies, not (necessarily) dependent on relative rotation, able to resist by storing energy over at least a last region of movement of said one subassembly when moving opposite to the striking direction and to use energy, so stored, to assist acceleration of the said one subassembly in the striking direction.

22. The hammering apparatus of claim 21 wherein a free travel distance or substantially free travel distance can be provided for one of said components prior to the onset of any substantial collection of energy from the relative movement of that component in a direction for use in return travel to enhance the return travel causing forces of any repulsive and/or attractive forces generated otherwise than by the said magnetic arrays.

23. The hammering apparatus of claim 21 wherein the release of the energy is or will be synchronised to the magnetic arrays interacting to cause said relative acceleration.

24. The hammering apparatus of claim 21 wherein said interactive arrangement can act as a recoil device were there notionally axial relative movement and no relative rotation between the subassemblies.

25. The hammering apparatus of claim 21 wherein said interactive arrangement does not tether one assembly to the other.
